(19) United States
(12) Patent Application Publication
(10) Pub. No.: US 2010/0071721 A1
(43) Pub. Date: Mar. 25, 2010

(54) Masonry Mold Cleaning Apparatus And Method

(76) Inventors: Eric S. Walsh, Chester, SC (US); Jonathan M. Verhoff, Reynoldsburg, OH (US); David K. Myers, Rock Hill, SC (US)

Correspondence Address: OWENS CORNING, 2790 COLUMBUS ROAD, GRANVILLE, OH, 43023, US

(21) Appl. No.: 12/234,944

(22) Filed: Sep. 22, 2008

(51) Int. Cl. B08B 1/02

(52) U.S. Cl. 134/6; 15/93.4

(57) ABSTRACT

A mold cleaning apparatus and method is provided for removing debris from an advancing masonry mold product. At least one rotatable tire is arranged at an acute angle to the masonry mold product and engages the mold product to provide a cleaning or scraping force to remove debris from the mold product. The cleaning force of the tire can be adjusted by changing the angle of the tire, the air pressure of the tire or the height of the tire relative to the mold surface. Multiple tires can be employed, while being rotated periodically to evenly distribute wear or replaced as needed.

### TECHNICAL FIELD AND INDUSTRIAL APPLICABILITY OF THE INVENTION

The present invention pertains to the art of molding and, more particularly, to a masonry mold cleaning apparatus and method.

### BACKGROUND OF THE INVENTION

In casting manufactured stone or brick, it is known to introduce a masonry product, such as pre-mixed concrete, into molds. Once the concrete is cured sufficiently, the manufactured stones are removed from the mold, leaving some hardened concrete residue behind. Before the mold can be utilized again, this hardened residue must be removed. Various manual methods have been utilized in the past to clean the molds, including chipping away at the concrete with a hammer and chisel. Such cleaning methods can be hazardous and time consuming. There is therefore seen to exist a need for a safer, more efficient and effective method of removing concrete residue from the molds.

### SUMMARY OF THE INVENTION

The present invention is directed to a mold cleaning apparatus and method utilizing tires. More specifically, a plurality of tires are supported in a freely rotating manner by axles extending from one or more supports. Masonry mold portions are advanced along guides past the mold cleaning apparatus. The tires are arranged at an acute angle to the direction of movement of the mold portions and engage the surfaces of the mold portions, thereby creating a cleaning force which scrapes masonry debris from the surfaces of the mold portions.

In accordance with one embodiment of the invention, the tires are connected to support structure through respective arms which can be adjusted to alter the angle of the tires with respect to the mold portions. Additionally, air supply hoses are connected to the tires and may be utilized to change the air pressure in the tires, thus changing the contact force between the tires and the mold portions. Further, adjustments can be made by raising or lowering the support structure with respect to the mold portions. The tires can be rotated periodically to evenly distribute wear on the tires and replaced with new tires when desired.

In accordance with another embodiment of the invention wherein a corner mold having first and second relatively angled wall portions is produced, a first tire is adjusted for contacting and cleaning the first wall portion of the corner mold, while a second tire, arranged substantially perpendicular to the first tire, is adjusted for contacting and cleaning the second wall portion of the corner mold. In a corresponding manner, the present invention may be utilized with a number of mold configurations.

Additional objects, features and advantages of the present invention will become more readily apparent from the following detailed description of the embodiments when taken in conjunction with the drawings wherein like reference numerals refer to corresponding parts in the several views.

### BRIEF DESCRIPTION OF THE DRAWINGS

FIG. 1 is a perspective side view of the concrete mold cleaning apparatus of the present invention in a lowered, engaged position;

FIG. 2 is a perspective front view of the concrete mold cleaning apparatus of FIG. 1 in a raised, disengaged position; and

FIG. 3 is a perspective view of an alternative embodiment of the mold cleaning apparatus of the present invention in an engaged position.

### DETAILED DESCRIPTION OF THE PREFERRED EMBODIMENTS

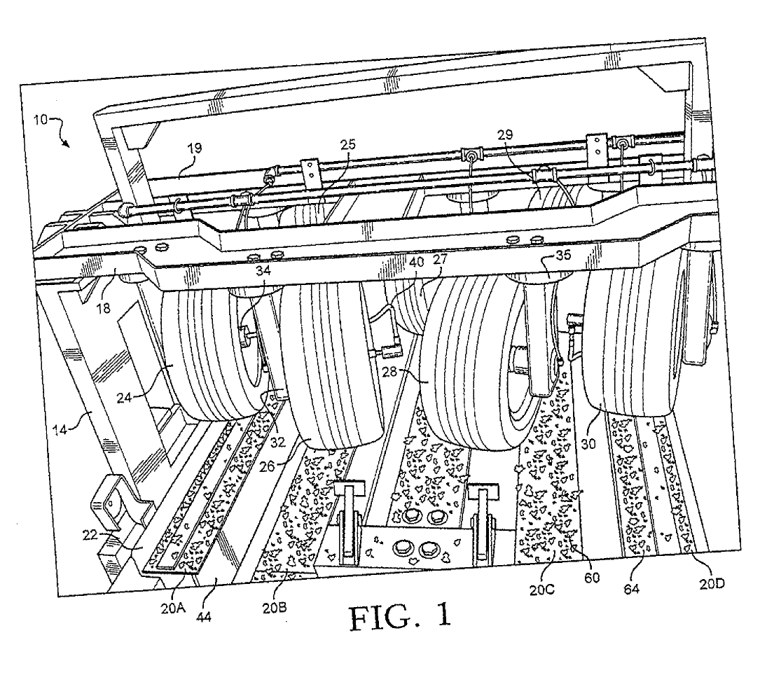

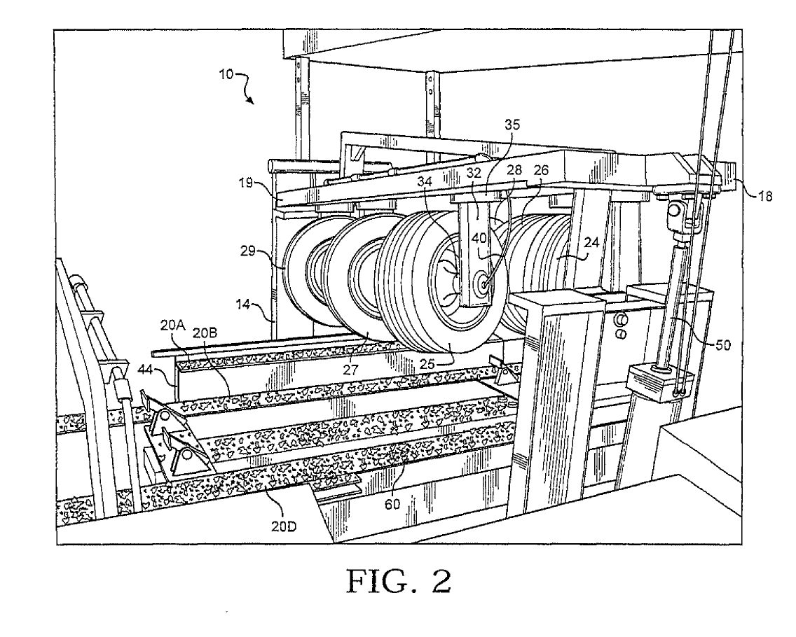

With initial reference to FIGS. 1 and 2, a masonry mold cleaning apparatus constructed in accordance with the present invention is generally indicated at 10. Basically, the apparatus is intended to clean a masonry mold product such as a manufactured stone or brick wall strip made from pouring concrete into a mold. In general, apparatus 10 includes a main frame 14 having supports 18 and 19 which extend over a plurality of mold portions 20A-20D. Mold portions 20A-20D are movably mounted on guides, such as platforms indicated at 22. At this point, it should be understood that guides 22 can take various forms, such that mold portions 20A-20D could be moved upon flat plates, rollers, conveyor structure or the like without departing from the invention. More importantly, a plurality of tires 24-30 are mounted from supports 18 and 19 by respective arms 32. More specifically, tires 24-30 are freely rotatably supported by axles 34 which extend substantially perpendicular from arms 32, while each arm 32 is rotatably connected to a respective support 18, 19 through a rotatable mount 35. In this manner, each tire 24-30 can be independently rotated about a substantially horizontal axis defined by a respective axle 34, as well as independently adjusted about a substantially vertical axis by rotation of a respective arm 34 relative to supports 18 and 19. In accordance with the invention, tires 24-30 may be any type of standard tire arrangement. Preferably, tires 24-30 constitute pneumatic, rubber tires mounted on rims, not labeled. In one embodiment, golf cart tires with standard rims are employed.

In accordance with the invention as clearly shown in FIGS. 1 and 2, each tires 24-30 is positioned at an acute angle (preferably in the range of about 5-45 degrees) to the direction of travel of mold portions 20A-20D. Since arms 32 are independently, rotatably mounted to respective supports 18 and 19, the angle of tires 24-30 with respect to mold portions 20A-20D can be selectively adjusted. As should be evident from the above, adjusting the angle of tires 24-30 with respect to mold portions 20A-20D adjusts the amount of drag or friction created between the surface of a respective tire 24-30 and the surface of a respective mold portion 20A-20D. With this configuration, a mold batch which results in particularly dirty mold portions 20A-20D can be provided with the desired amount of cleaning force by adjusting the angle of tires 24-30, thereby altering the effective scraping of the mold surfaces.

The cleaning action of the apparatus of the invention can also be adjusted in additional ways. As indicated above, tires 24-30 are typically pneumatic. Along these lines, tires 24-30 are typically provided with respective air supply hoses 40 which are connected to a pneumatic source and controller (not shown). With this configuration, a user may adjust the air pressure in respective tires 24-30 as desired, thereby providing for additional control over the contact forces between the surfaces of tires 24-30 and mold portions 20A-20D during a cleaning event. In accordance with one embodiment of the invention, an air pressure of at least about 15 psi is utilized for tires 24-30. In addition, the preferred embodiment of the invention shown employs guides 22 including a brace 44 which fully supports mold portions 20A-20D from below, thereby allowing the desired amount of pressure to be applied to the surface of mold portions 20A-20D while preventing any bowing of mold portions 20A-20D. In another embodiment the tire air pressure can be less than 15 psi.

As a still further adjustment feature, apparatus 10 is vertically adjustable. More specifically, supports 18 and 19 of apparatus 10 can be selectively raised or lowered to reposition tires 24-30 vertically between an activated or engaged position with mold portions 20A-20D as depicted in FIG. 1 to a deactivated or disengaged position wherein tires 24-30 are spaced above mold portions 20A-20D as shown in FIG. 2. To accomplish this shifting feature in accordance with an embodiment apparatus 10 includes a lifting device in the form of pneumatic cylinders 50 connected to a user control (not shown). Pneumatic cylinders 50 may also be utilize as a means for applying downward pressure to create a desired amount of cleaning contact between tires 24-30 and mold portions 20A-20D.

In use, a hydraulic pusher (not shown) is operated to advance mold portions 20A-20D along guides 22 and past apparatus 10. As the surfaces of tires 24-30 contact the surfaces of mold portions 20A-20D, masonry residue, indicated at 60 in FIG. 2, is scraped from mold portions 20A-20D, whereupon the residue 60 falls to a lower level 64. Lower level 64 is preferably easily accessible in order to provide for easy clean-up. By the use of apparatus 10, tires 24-30 will certainly show wear over time. Therefore, it is desirable to periodic rotate tires 24-30 in order to distribute the wear more evenly along the surface of the tires 24-30. After tires 24-30 have obtained a certain amount of wear, or when otherwise desirable, tires 24-30 may be replaced with a new set of tires.

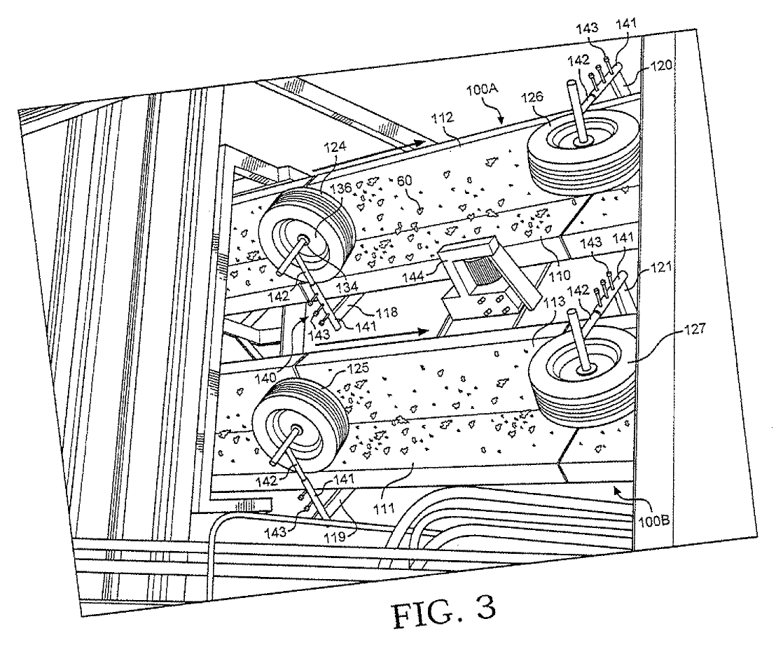

Although shown in use with flat mold portions 20A-20D in FIGS. 1 and 2, the present invention can also be utilized with corner mold portions 100A and 100B as depicted in FIG. 3. As shown, each of corner mold portions 100A and 100B includes a first wall portion 10, 111 and a second wall portion 112, 113. More specifically, supports 118-120 carry respective tires 124-127 above mold portions 100A and 100B, such that tires 124 and 125 engage respective first wall portions 110 and 111 and tires 126 and 127 engage respective second wall portions 112 and 113. More specifically, each tire 124-127 is freely rotatably mounted on a respective axle 134 suspended from a support 118-120 through an arm 140. Each arm 140 is defined by two telescoping tubes 141 and 142, with tube 141 being fixed to a respective support 18 and 120 and telescopingly receiving tube 142. In order to provide for angle and engagement force adjustments, tube 142 can be slid into and out of, as well as rotated within, tube 141. Once a desired position is established for a given wheel 124-127, tubes 141 and 142 are fixed relative to each other. This function can be performed in a number of ways however, in the embodiment shown, a plurality of threaded fasteners or bolts 143 are threadably engaged with tube 141 and can be selectively tightened against tube 142.

In addition, in a manner corresponding to that set forth above with respect to the embodiment of FIGS. 1 and 2, supports 118-121 can be pneumatically or otherwise shifted relative to the mold portions 100A and 100B to further varying the engagement force between tires 124-127 and mold portions 100A and 100B. For instance, a manual adjusting arrangement, such as a crank arm system, could be employed for this purpose. As with the first embodiment, tires 124-127 and wheels 136 may be any type of standard wheel and tire arrangement. Tires 124-127 are mounted at an acute angle to the direction of travel of mold portions 100A and 100B, with the angling of tires 124-127 being adjustable, depending on the amount of cleaning force desired. In any case, during a cleaning operation, mold portions 100A and 100B are advanced in a direction indicated by the arrows in FIG. 3 by pushers 144, tires 124-127 engage the surface of mold portions 100A and 100B, and a shearing force which scrapes debris 60 from mold portions 100A and 100B is applied.

Although described with reference to preferred embodiments of the invention, it should be readily understood that various changes and/or modifications can be made to the invention without departing from the spirit thereof. For instance, although depicted with a specific number and relative size of tires, it should be understood that any desired number and size of tires can be utilized for cleaning any desired number of mold portions. In addition, additional cleaning structure could be further employed, such as a wiping system in the form of a rubber, steel or the like headed brush, and/or a spray washing system. In general, the invention is only intended to be limited by the scope of the following claims.

I/We claim:

1. A mold cleaning apparatus for cleaning residue from a molded product comprising:
a mold guide for carrying a molded product through the apparatus along a direction of travel;
a support disposed vertically offset from the mold guide;
an axle extending from the support; and
a tire rotatably mounted on the axle and arranged at an acute angle to the direction of travel, with said tire being adapted to engage the molded product as the molded product moves along the direction of travel in order to scrape mold residue from the molded product.

2. The mold cleaning apparatus of claim 1, further comprising an arm mounted for rotation relative to the support, wherein the axle projects from the arm such that rotation of the arm relative to the support causes the acute angle of the tire to be adjusted.

3. The mold cleaning apparatus of claim 2, wherein the arm comprises a pair of telescoping members.

4. The mold cleaning apparatus of claim 1, further comprising an air hose connected to the tire for supplying pressurized air to the tire, wherein adjusting the air pressure of the tire alters an engagement force between the tire and the molded product.

5. The mold cleaning apparatus of claim 4, wherein the air pressure of the tire is set at least about 15 psi.

6. The mold cleaning apparatus of claim 1, further comprising a lifting device for adjusting a height of the tire relative to the mold guide.

7. The mold cleaning apparatus of claim 6, wherein the lifting device is constituted by pneumatic cylinders.

8. The mold cleaning apparatus of claim 7, wherein the pneumatic cylinders are attached to the support such that the height of the tire is indirectly shifted relative to the mold guide.

9. The mold cleaning apparatus of claim 1, wherein the mold product constitutes a molded masonry product.

10. The mold cleaning apparatus of claim 9, further comprising another tire rotatably mounted to another axle extending from the support at a position spaced from said tire, wherein another tire is also mounted at an acute angle to the direction of travel.

11. The mold cleaning apparatus of claim 10, wherein the mold product is a coiner concrete mold product having first and second angled wall portions, with said tire engaging the first wall portion and another tire engaging the second wall portion.

12. A method of cleaning a masonry mold product comprising:
advancing a masonry mold product a direction of travel; and
engaging a tire, mounted for rotation at an acute angle to the direction of travel, with the masonry mold product such that the tire applies a cleaning force to the masonry mold product as the masonry mold product advances.

13. The method of claim 12, further comprising adjusting air pressure of the tire to alter the cleaning force.

14. The method of claim 12, further comprising adjusting the acute angle of the tire to adjust the cleaning force.

15. The method of claim 12, further comprising adjusting a height of the tire relative to the masonry mold product to adjust the cleaning force.

16. The method of claim 15, further comprising vertically shifting a support carrying the tire in order to adjust the height of the tire relative to the masonry mold product.

17. The method of claim 12, further comprising periodically rotating the tire to distribute wear created on the tire during cleaning.

18. The method of claim 12, further comprising periodically replacing the tire with another tire.

19. The method of claim 12, further comprising mounting another tire at a position spaced from said tire wherein another tire is also mounted at an acute angle to the direction of travel and engages the masonry mold product for cleaning purposes.

20. The method of claim 19, further comprising engaging the tire with a first wall portion of the masonry mold product and another tire with a second wall portion of the masonry mold product, wherein the first and second walls are angled relative to each other.
